(19) United States
(12) Patent Application Publication
(10) Pub. No.: US 2020/0372515 A1
(43) Pub. Date: Nov. 26, 2020

(54) PRODUCT CERTIFICATION SYSTEM

(71) Applicant: E-CENTURY TECHNICAL & INDUSTRIAL CORPORATION, NEW TAIPEI CITY (TW)

(72) Inventor: I-Kuang LAI, NEW TAIPEI CITY (TW)

(21) Appl. No.: 16/567,768

(22) Filed: Sep. 11, 2019

(30) Foreign Application Priority Data
May 23, 2019 (TW) 108206516

(51) Int. Cl. G06Q 30/00; H04W 4/35; H04W 4/80; G06K 7/14

(52) U.S. Cl. CPC G06Q 30/012; H04W 4/35; G06K 7/1417; G06Q 30/018; G06K 7/1413; H04W 4/80

(57) ABSTRACT

A product certification system includes a short distance communication reader and a short distance communication integrated circuit. The short distance communication reader downloads an application program from a data base. The short distance communication reader installs the application program and utilizes the application program to register with the data base. The short distance communication reader receives a short distance communication password and a serial number of the short distance communication integrated circuit. The short distance communication reader uploads the short distance communication password and the serial number to the data base. The data base determines the short distance communication password and the serial number to obtain a comparison result signal. The data base sends the comparison result signal to the short distance communication reader, so that the short distance communication reader displays a comparison result of the comparison result signal.

### BACKGROUND OF THE INVENTION

### Field of the Invention

The present invention relates to a certification system, and especially relates to a product certification system.

### Description of the Related Art

The related art product certification system is used to identify the authenticity of the product, so that the buyer can buy the real product, and the maker can obtain the deserved reward, to be beneficial to the positive circulation of the manufacturing and consumption. Therefore, the related art product certification system is very important.

However, currently the disadvantage of the related art product certification system is that the related art product certification system is too complex. Moreover, currently the related art product certification system does not have any other additional technology, for example, a simple product registration procedure.

### SUMMARY OF THE INVENTION

In order to solve the above-mentioned problems, an object of the present invention is to provide a product certification system.

In order to achieve the object of the present invention mentioned above, the product certification system of the present invention is applied to a product and a data base. The product certification system comprises a short distance communication reader and a short distance communication integrated circuit. The short distance communication reader is wirelessly connected to the data base. The short distance communication integrated circuit is wirelessly connected to the short distance communication reader. The short distance communication integrated circuit is connected to the product. Moreover, the short distance communication reader comprises a processor, a display, a short distance communication circuit and a long distance communication circuit. The display is electrically connected to the processor. The short distance communication circuit is electrically connected to the processor. The short distance communication circuit is wirelessly connected to the short distance communication integrated circuit. The long distance communication circuit is electrically connected to the processor. The long distance communication circuit is wirelessly connected to the data base. Moreover, the processor is configured to download an application program from the data base through the long distance communication circuit. The processor is configured to install the application program and is configured to utilize the application program to register with the data base through the long distance communication circuit to upload a registration information to the data base. Moreover, the processor is configured to utilize the application program to receive a short distance communication password and a serial number of the short distance communication integrated circuit through the short distance communication circuit. After the processor receives the short distance communication password and the serial number of the short distance communication integrated circuit, the processor is configured to utilize the application program to upload the short distance communication password and the serial number of the short distance communication integrated circuit to the data base through the long distance communication circuit. After the data base receives the short distance communication password and the serial number of the short distance communication integrated circuit, the data base is configured to utilize a comparison table of the data base to compare and determine the short distance communication password and the serial number of the short distance communication integrated circuit to obtain a comparison result signal. After the data base receives the comparison result signal, the data base is configured to send the comparison result signal to the long distance communication circuit. After the long distance communication circuit receives the comparison result signal, the long distance communication circuit is configured to send the comparison result signal to the processor, so that the processor is configured to utilize the display to display a comparison result of the comparison result signal.

The advantage of the present invention is to provide a product certification system with a simple process. Moreover, the present invention can utilize a simple product registration procedure to control/monitor the quantity of the overall products.

Please refer to the detailed descriptions and figures of the present invention mentioned below for further understanding the technology, method and effect of the present invention achieving the predetermined purposes. It believes that the purposes, characteristic and features of the present invention can be understood deeply and specifically. However, the figures are only for references and descriptions, but the present invention is not limited by the figures.

### BRIEF DESCRIPTION OF DRAWING

FIG. 1 shows a block diagram of an embodiment of the product certification system of the present invention.

FIG. 2 shows a block diagram of the short distance communication reader registering with the data base of the present invention.

FIG. 3 shows a block diagram of the authenticity verification of the product certification system of the present invention.

FIG. 4 shows a block diagram of the product registration of the product certification system of the present invention.

### DETAILED DESCRIPTION OF THE INVENTION

In the present disclosure, numerous specific details are provided, to provide a thorough understanding of embodiments of the invention. Persons of ordinary skill in the art will recognize, however, that the present invention can be practiced without one or more of the specific details. In other instances, well-known details are not shown or described to avoid obscuring aspects of the present invention. Now please refer to the figures for the explanation of the technical content and the detailed description of the present invention:

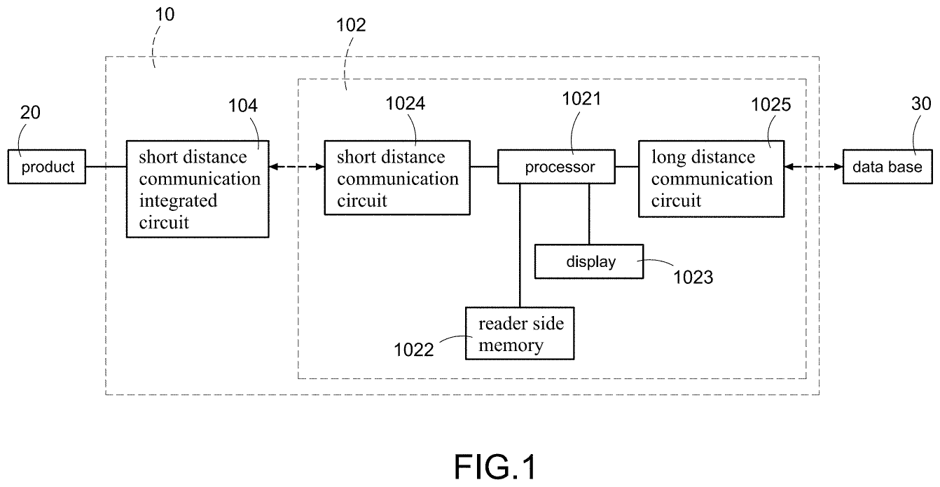

FIG. 1 shows a block diagram of an embodiment of the product certification system of the present invention. A product certification system 10 of the present invention is applied to a product 20 and a data base 30. The product certification system 10 comprises a short distance communication reader 102 and a short distance communication integrated circuit 104. The short distance communication reader 102 comprises a processor 1021, a reader side memory 1022, a display 1023, a short distance communication circuit 1024 and a long distance communication circuit 1025. The components mentioned above are connected/wirelessly connected/electrically connected to each other.

The short distance communication reader 102 is, for example but not limited to, a near field communication reader, a radio frequency identification reader or other reading apparatuses equipped with wireless communication technologies, for example, a smartphone. The long distance communication circuit 1025 is, for example but not limited to, a wireless fidelity communication circuit. The data base 30 is, for example but not limited to, a cloud data base. If the short distance communication reader 102 is a near field communication reader, the short distance communication integrated circuit 104 is a near field communication integrated circuit, and the short distance communication circuit 1024 is a near field communication circuit. If the short distance communication reader 102 is a radio frequency identification reader, the short distance communication integrated circuit 104 is a radio frequency identification integrated circuit, and the short distance communication circuit 1024 is a radio frequency identification communication circuit.

Moreover, the short distance communication integrated circuit 104 comprises rewritable data areas (which can be locked with passwords), for examples, inputting characters, web sites, Email addresses, locations, Bluetooth information, and so on.

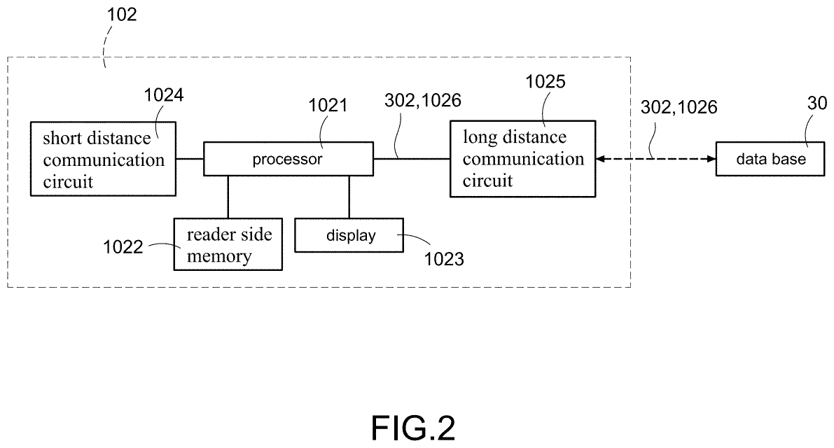

The product certification system of the present invention comprises two parts: the authenticity verification and the product registration. Firstly, the short distance communication reader 102 has to register with the data base 30 to obtain an application program to proceed the authenticity verification and the product registration. FIG. 2 shows a block diagram of the short distance communication reader registering with the data base of the present invention. The processor 1021 is configured to download an application program 302 (APP) from the data base 30 through the long distance communication circuit 1025. The processor 1021 is configured to install the application program 302 and is configured to utilize the application program 302 to register with the data base 30 through the long distance communication circuit 1025 to upload a registration information 1026 to the data base 30. The registration information 1026 can comprise the user's name, telephone number, address, and so on.

Then, the authenticity verification and the product registration of the product certification system of the present invention are respectively described in details as following:

1. The Authenticity Verification:

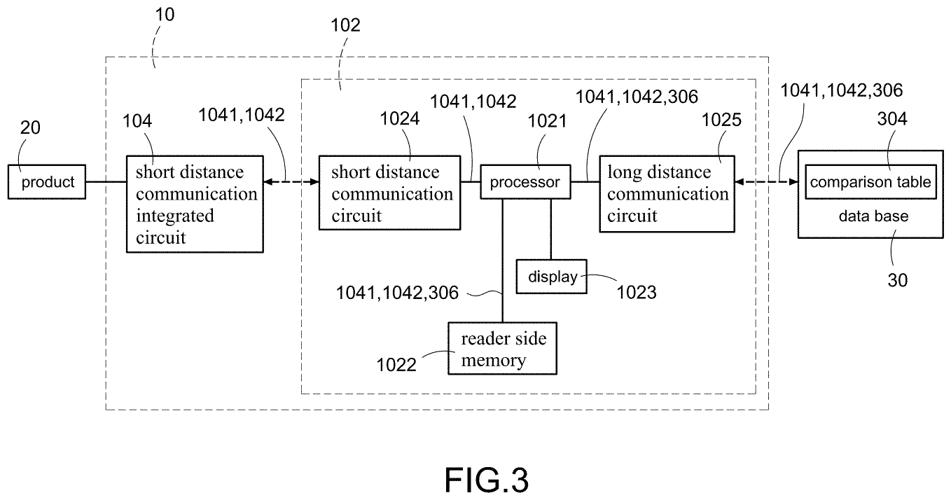

FIG. 3 shows a block diagram of the authenticity verification of the product certification system of the present invention. The processor 1021 is configured to utilize the application program 302 (as shown in FIG. 2) to receive a short distance communication password 1041 and a serial number 1042 of the short distance communication integrated circuit 104 through the short distance communication circuit 1024. For example, the processor 1021 is close to the short distance communication integrated circuit 104 to receive the short distance communication password 1041 and the serial number 1042 of the short distance communication integrated circuit 104 After the processor 1021 receives the short distance communication password 1041 and the serial number 1042 of the short distance communication integrated circuit 104, the processor 1021 is configured to utilize the application program 302 to upload the short distance communication password 1041 and the serial number 1042 of the short distance communication integrated circuit 104 to the data base 30 through the long distance communication circuit 1025. After the data base 30 receives the short distance communication password 1041 and the serial number 1042 of the short distance communication integrated circuit 104, the data base 30 is configured to utilize a comparison table 304 of the data base 30 to compare and determine the short distance communication password 1041 and the serial number 1042 of the short distance communication integrated circuit 104 to obtain a comparison result signal 306. For example, the data base 30 utilizes the comparison table 304 to compare the short distance communication password 1041 with a first short distance communication password (not shown in FIG. 3) of the comparison table 304; the data base 30 utilizes the comparison table 304 to compare the serial number 1042 with a first serial number (not shown in FIG. 3) of the comparison table 304; if the short distance communication password 1041 is equal to the first short distance communication password, and if the serial number 1042 is equal to the first serial number, the comparison result signal 306 indicates that the product 20 is determined as true. After the data base 30 receives the comparison result signal 306, the data base 30 is configured to send the comparison result signal 306 to the long distance communication circuit 1025. After the long distance communication circuit 1025 receives the comparison result signal 306, the long distance communication circuit 1025 is configured to send the comparison result signal 306 to the processor 1021, so that the processor 1021 is configured to utilize the display 1023 to display a comparison result (namely, the authenticity of the product 20) of the comparison result signal 306. Therefore, the user can be aware of the authenticity of the product 20. The reader side memory 1022 is configured to store the short distance communication password 1041, the serial number 1042 and the comparison result signal 306.

Moreover, the processor 1021 can also be configured to utilize the application program 302 to receive other product information (which can be read but cannot be modified/changed) of the short distance communication integrated circuit 104 through the short distance communication circuit 1024, for examples, a brand of the product 20, a production date of the product 20, a title/name of the product 20, and so on. The short distance communication password 1041 cannot be displayed. The short distance communication password 1041 cannot be modified/changed. The processor 1021 is configured to utilize the display 1023 to display the comparison result of the comparison result signal 306, and to display other product information mentioned above of the short distance communication integrated circuit 104. The reader side memory 1022 is configured to further store other product information mentioned above of the short distance communication integrated circuit 104.

2. The Product Registration:

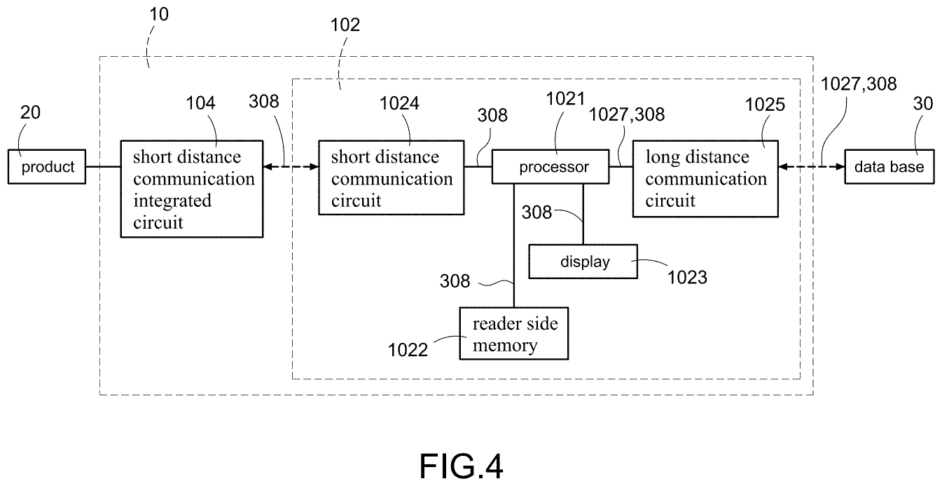

FIG. 4 shows a block diagram of the product registration of the product certification system of the present invention. The processor 1021 is configured to utilize the application program 302 (as shown in FIG. 2) to upload a product registration code 1027 of the product 20 to the data base 30 through the long distance communication circuit 1025, so that the data base 30 is configured to proceed a product registration procedure of the product 20. After the product registration procedure of the product 20 is finished, the data base 30 is configured to generate a registration success signal 308 with a warranty start date. After the data base 30 generates the registration success signal 308, the data base 30 is configured to send the registration success signal 308 to the long distance communication circuit 1025. After the long distance communication circuit 1025 receives the registration success signal 308, the long distance communication circuit 1025 is configured to send the registration success signal 308 to the processor 1021, so that the processor 1021 is configured to utilize the display 1023 to display a registration success result of the registration success signal 308, and the processor 1021 is configured to utilize the application program 302 to send the registration success signal 308 to the short distance communication integrated circuit 104 through the short distance communication circuit 1024, so that the short distance communication integrated circuit 104 is configured to record the warranty start date of the registration success signal 308. The reader side memory 1022 is configured to further store the registration success signal 308.

Moreover, the product registration code 1027 of the product 20 can be, for example, written on the guarantee of the product 20. For example, the product registration code 1027 of the product 20 can be a QR code or a barcode; the short distance communication reader 102 scans the product registration code 1027 written on the guarantee of the product 20 to input the product registration code 1027 of the product 20. The reader side memory 1022 is configured to further store the product registration code 1027. The short distance communication integrated circuit 104 can record the warranty start date of the registration success signal 308 only one time. The warranty start date of the registration success signal 308 can be read.

The advantage of the present invention is to provide a product certification system with a simple process. Moreover, the present invention can utilize a simple product registration procedure to control/monitor the quantity of the overall products.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A product certification system applied to a product and a data base, the product certification system comprising:
a short distance communication reader wirelessly connected to the data base; and
a short distance communication integrated circuit wirelessly connected to the short distance communication reader and connected to the product,
wherein the short distance communication reader comprises:
a processor;
a display electrically connected to the processor;
a short distance communication circuit electrically connected to the processor and wirelessly connected to the short distance communication integrated circuit; and
a long distance communication circuit electrically connected to the processor and wirelessly connected to the data base,
wherein the processor is configured to download an application program from the data base through the long distance communication circuit; the processor is configured to install the application program and is configured to utilize the application program to register with the data base through the long distance communication circuit to upload a registration information to the data base;
wherein the processor is configured to utilize the application program to receive a short distance communication password and a serial number of the short distance communication integrated circuit through the short distance communication circuit; after the processor receives the short distance communication password and the serial number of the short distance communication integrated circuit, the processor is configured to utilize the application program to upload the short distance communication password and the serial number of the short distance communication integrated circuit to the data base through the long distance communication circuit; after the data base receives the short distance communication password and the serial number of the short distance communication integrated circuit, the data base is configured to utilize a comparison table of the data base to compare and determine the short distance communication password and the serial number of the short distance communication integrated circuit to obtain a comparison result signal; after the data base receives the comparison result signal, the data base is configured to send the comparison result signal to the long distance communication circuit; after the long distance communication circuit receives the comparison result signal, the long distance communication circuit is configured to send the comparison result signal to the processor, so that the processor is configured to utilize the display to display a comparison result of the comparison result signal.

2. The product certification system in claim 1, wherein the short distance communication reader further comprises:
a reader side memory electrically connected to the processor,
wherein the processor is configured to utilize the application program to upload a product registration code of the product to the data base through the long distance communication circuit, so that the data base is configured to proceed a product registration procedure of the product; after the product registration procedure of the product is finished, the data base is configured to generate a registration success signal with a warranty start date; after the data base generates the registration success signal, the data base is configured to send the registration success signal to the long distance communication circuit; after the long distance communication circuit receives the registration success signal, the long distance communication circuit is configured to send the registration success signal to the processor, so that the processor is configured to utilize the display to display a registration success result of the registration success signal, and the processor is configured to utilize the application program to send the registration success signal to the short distance communication integrated circuit through the short distance communication circuit, so that the short distance communication integrated circuit is configured to record the warranty start date of the registration success signal;
wherein the reader side memory is configured to store the short distance communication password, the serial number, the comparison result signal and the registration success signal.

3. The product certification system in claim 2, wherein the short distance communication reader is a near field communication reader.

4. The product certification system in claim 3, wherein the short distance communication integrated circuit is a near field communication integrated circuit.

5. The product certification system in claim 4, wherein the short distance communication circuit is a near field communication circuit.

6. The product certification system in claim 2, wherein the short distance communication reader is a radio frequency identification reader.

7. The product certification system in claim 6, wherein the short distance communication integrated circuit is a radio frequency identification integrated circuit.

8. The product certification system in claim 7, wherein the short distance communication circuit is a radio frequency identification communication circuit.

9. The product certification system in claim 2, wherein the short distance communication reader is a smartphone.

10. The product certification system in claim 9, wherein the long distance communication circuit is a wireless fidelity communication circuit; the data base is a cloud data base.
